(19) United States
(12) Patent Application Publication
(10) Pub. No.: US 2015/0240556 A1
(43) Pub. Date: Aug. 27, 2015

(54) Sealing Strip

(71) Applicants: Robert T. Ellingson, Social Circle, GA (US); Dennis L. Harms, JR., Covington, GA (US)

(72) Inventors: Robert T. Ellingson, Social Circle, GA (US); Dennis L. Harms, JR., Covington, GA (US)

(73) Assignee: REESE ENTERPRISES, INC., Covington, GA (US)

(21) Appl. No.: 14/268,029

(22) Filed: May 2, 2014

Related U.S. Application Data
(63) Continuation-in-part of application No. 29/483,191, filed on Feb. 26, 2014.

(51) Int. Cl. E06B 7/23

(52) U.S. Cl. CPC E06B 7/231; E06B 7/2314

(57) ABSTRACT

The present disclosure describes various embodiments, as well as features and aspects thereof, of a sealing strip that can function to create a thermal, gas, liquid and/or particulate barrier between the primary surface and the secondary surface when the two are mated. More specifically, one embodiment of the sealing strip includes a coupling portion for detachably coupling the sealing strip to a primary surface, a gasket portion defining a channel and a channel insert; the gasket portion having a flexing portion, a flex point and a channel; the channel insert configured to fill at least a portion of the channel, to fit at least partially within said channel and to extend along at least a partial length of said channel.

### CROSS-REFERENCE TO RELATED APPLICATIONS

This application is a continuation-in-part of, and claims priority under 35 U.S.C. §120 to, the U.S. design patent application entitled “DOOR JAMB SEAL,” filed on Feb. 26, 2014 and assigned application Ser. No. 29/483,191, the entire contents of which are hereby incorporated by reference.

### BACKGROUND

The present disclosure relates to a sealing gasket between two or more mating surfaces and, more particularly, to a sealing gasket between a frame defining an opening (“an opening frame”), e.g., door opening or window opening, and a structure that mates with the frame to at least partially block off the opening (“a closure member”), e.g, door or window.

It is frequently necessary to employ a sealing gasket for the purpose of providing a thermal, gas, liquid and/or particulate barrier between an opening frame and a closure member. For this purpose, an elongated sealing gasket may be attached to at least a portion of the opening frame; usually, at a portion where a gap would exist between the opening frame and the closure member when the two are mated. Prior art sealing gaskets function to fill this gap by engaging with the closure member; the closure member moves/deforms/compresses the sealing gasket when the closure member mates with the opening frame and the sealing gasket resists the movement/deformation/compression by exerting a static force (e.g., from a spring built into the sealing gasket, from an inherent elastomeric property of the sealing gasket, etc.) against the closure member.

For example, FIG. 1 is a top and side perspective view of one common prior art embodiment of a system 101 incorporating an opening frame 102, a closure member 103 and a sealing gasket 104; the components being bisected to reveal a cross-section; and the components being depicted as one common prior art embodiment of their respective selves. Opening frame 102 and closure member 103 are configured to mate with one another for the purpose of at least partially blocking off the opening defined by opening frame 102. Sealing gasket 104 is configured to function as a sealing gasket for the gap between opening frame 102 and closure member 103 when the two are mated.

FIG. 2 is a “zoomed-in” top and side cross-sectional view of opening frame 102 and sealing gasket 104 of FIG. 1. Portion 105 of sealing gasket 104 substantially and primarily functions as a gasket. In FIG. 2, a cross-sectional area of portion 105 is depicted; the shape, volume, density and material composition of this cross-sectional area is substantially equal to that of any other parallel cross-sectional area along the length of portion 105. In the prior art, this characteristic is substantially shared by all embodiments of sealing gasket 104. The core of portion 105 is generally made of a natural or synthetic elastomer protected by an outer liner made of a more durable material.

Returning to FIG. 1, wear and tear 106 to portion 105 is the most ubiquitous significant deficiency amongst the prior art embodiments of sealing gasket 104. An inherent characteristic of sealing gasket 104, due to its intended function, is degradation over time; this is generally due to: repeated mechanical interactions, e.g., repeated cycles of movement, deformation, compression, etc. when the seal is engaged or disengaged; or exposure to erosive forces (for example, from objects/particulates passing through the opening defined by opening frame 102, or the gap between opening frame 102 and closure member 103 when the two are mated.) Moreover, degradation can result from thermal or chemical interactions, e.g., exposure to extreme temperatures or humidity, or exposure to significant temperature or humidity fluctuations, relative to its intended use, when the seal is engaged or disengaged.

To make matters worse, natural and synthetic elastomers useful for the gasket function of portion 105 are less durable than previously used rigid or semi-rigid materials (less useful for the gasket function of portion 105). This is true even when portion 105 has a protective liner. This inherent degradation characteristic of sealing gasket 104 is substantially shared by the most commercially available prior art embodiments. It is no surprise, then, that the most commercially available prior art embodiments of sealing gasket 104 are also readily and easily detachable from system 101 (for ease of replacement).

Moreover, these embodiments substantially share another significant deficiency. In FIGS. 1-2, portion 105 of sealing gasket 104 has a relatively large volume of elastomeric material. The quality of the seal possible, between opening frame 102 and the closure member 103 when the sealing gasket is engaged, is directly related to the volume of elastomeric material in portion 105. While this may seem beneficial for all embodiments of sealing gasket 104, embodiments intended for consumer and commercial use suffer. The increased volume of portion 105 only provides insignificant decreasing marginal benefits in the quality of the seal, while: (1) limiting the elements that could be included in sealing gasket 104 (but for the increased volume of portion 105); (2) complicating the manufacturing of sealing gasket 104; and (3) insufficiently supplementing, or even negatively effecting, the firewall function of system 101.

Consequently, because prior art sealing gaskets suffer from the stated significant deficiencies, there is a need in the art for an improved sealing gasket that may: (1) establish a substantial and consistent seal; (2) maintain a uniform seal throughout its length; (3) resist thermal, mechanical and chemical degradation when engaged, when not engaged and over the course of repeated usage cycles; and (4) positively supplement system 101 when it functions as a firewall.

### SUMMARY

The present disclosure describes various embodiments, as well as features and aspects thereof, of a sealing strip that can: (1) solve all of the stated deficiencies in the prior; (2) channel expanding intumescent materials for an improved firewall seal; (3) supplant a previously installed prior art sealing strip; (4) minimize the use of redundant and/or unnecessary manufacturing materials; and/or (5) be effectively and efficiently manufactured by extrusion manufacturing processes.

More specifically, one embodiment of the sealing strip includes a coupling portion for detachably coupling the sealing strip to a primary surface, a gasket portion and a channel insert; the gasket portion having a cross-sectional area, shape and material composition at specific points along the gasket portion defining the shape and volume of the gasket portion at these specific points; the cross-sectional area, shape and material composition of multiple points along a length of the gasket portion defining the shape and volume of the gasket portion along that specific length; the general area, shape and material composition of the various cross-sections along the length of the gasket portion substantially defining a flexing portion, a flex point and a channel; the flexing portion configured to engage with a secondary surface such that the flexing portion flexes at the flex point when the coupling portion is coupled to the primary surface; the flex point resisting the flexing and forcing the flexing portion against the secondary surface; the channel having a greater internal volume when the flexing portion is engaged with the secondary surface than when the flexing portion is not engaged with the secondary surface; and a channel insert configured to fill at least a portion of the channel, to fit at least partially within said channel and to extend along at least a partial length of said channel. The resulting sealing strip functions to create a thermal, gas, liquid and/or particulate barrier between the primary surface and the secondary surface when the two are mated.

Various embodiments, configurations, features and aspects of the sealing strip are described in more detail in the detailed description with reference to the attached drawings.

### BRIEF DESCRIPTION OF THE SEVERAL VIEWS OF THE DRAWING

FIG. 1 is a top and side perspective view of one common prior art embodiment of a system 101 incorporating an opening frame 102, a closure member 103 and a sealing gasket 104; the components being bisected to reveal a cross-section; and the components being depicted as one common prior art embodiment of their respective selves.

FIG. 2 is a “zoomed-in” top and side cross-sectional view of opening frame 102 and sealing gasket 104 of FIG. 1.

FIG. 3 is a front top and side perspective view of one embodiment of a sealing strip 301.

FIG. 4 is a rear top and side perspective view of one embodiment of a sealing strip 301.

FIG. 5 is a top cross-sectional view of cross-sectional bisection 5 of sealing strip 301 of FIG. 4.

FIG. 6 is a top view of sealing strip 301 of FIG. 4.

FIGS. 7A-7B is a front top and side perspective view of one embodiment of a sealing strip 301 supplanting and supplementing one common prior art embodiment of sealing gasket 104 in system 101 of FIG. 1

### DETAILED DESCRIPTION OF VARIOUS EMBODIMENTS

The following written description explains various embodiments of a sealing strip. This written description refers to the appended drawings to supplement the written explanation and as such, the written words should not be construed as limitations. Numerous specific details are explained in the written description and depicted in the drawings to provide an enabling understanding of the various embodiments to one of ordinary skill in the art; however, some details need not be expressly explained because they are readily apparent and understood by one of ordinary skill in the art, e.g., for certain described embodiments, explanation of some specific details are omitted so as to not unnecessarily obscure the written description. Additionally, one of ordinary skill in the art will understand that the various embodiments may be practiced without some or all of these specific details.

Although throughout the detailed description, the various embodiments are directed towards a sealing strip, it should be understood that the focus of such description is only provided to ensure clarity in the configuration and operation of the various embodiments, and the description should not be used to limit the usefulness of the various embodiments in other manners or for other uses.

The various embodiments shown and described herein are related to a sealing strip; the various embodiments of the a sealing strip may be ideally suited for, without limitation: (1) solving all of the stated deficiencies in the prior art; (2) channeling expanding intumescent materials for an improved firewall seal; (3) supplanting a previously installed prior art sealing strip; (4) minimizing the use of redundant and/or unnecessary manufacturing materials; and (5) being effectively and/or efficiently manufactured by extrusion manufacturing processes.

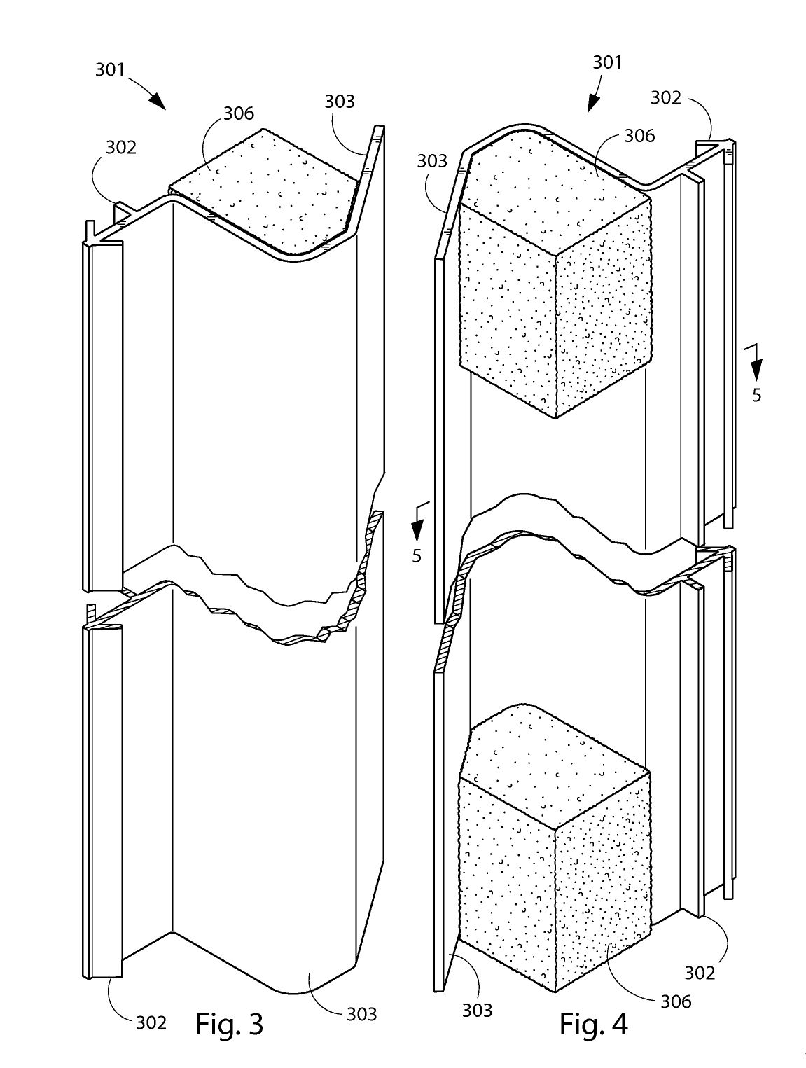

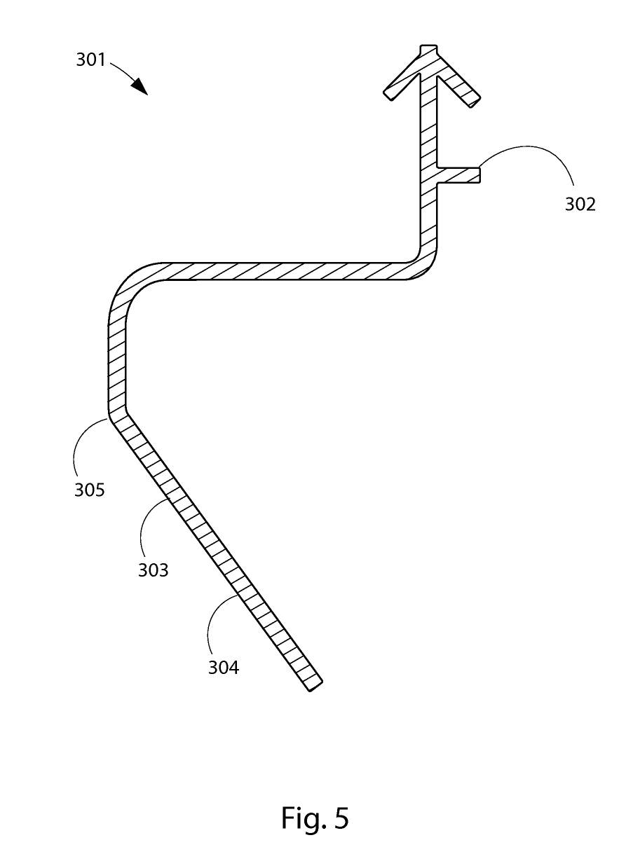

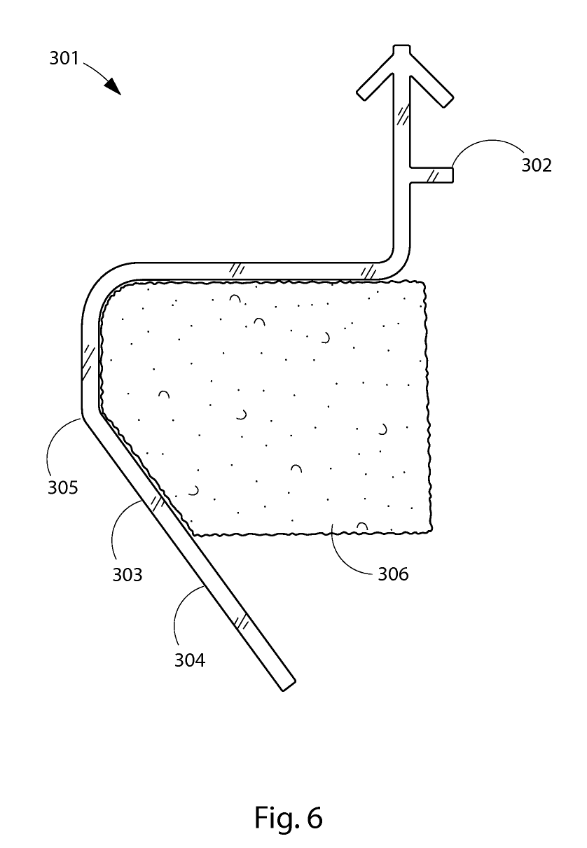

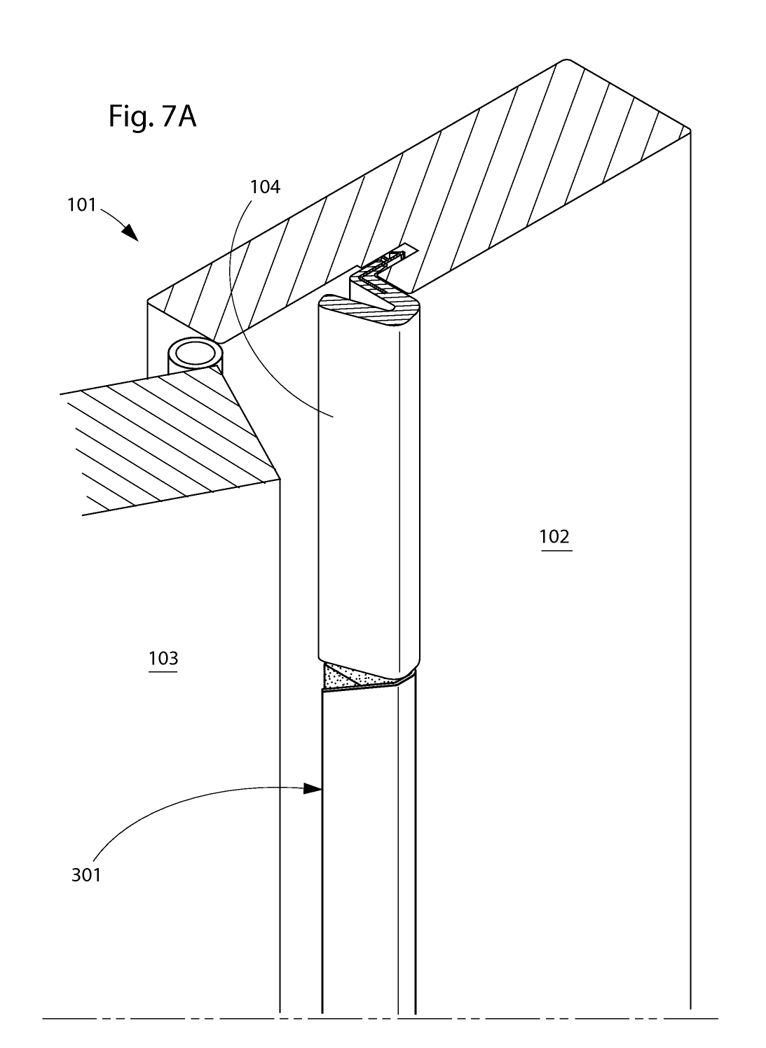

Referring now to the drawings wherein the showings are for purposes of illustrating the various embodiments of the present invention only, and not for purposes of limiting the same, FIG. 3-4 are top and side perspective views of one embodiment of a sealing strip 301. FIG. 3 is a view from the front; FIG. 4 is a view from the rear. FIG. 5 is a top cross-sectional view of cross-sectional bisection 5 of sealing strip 301 of FIG. 4; FIG. 6 is a top view of the same.

Sealing strip 301 is depicted as including a coupling portion 302 for detachably coupling the sealing strip 301 to another surface and a gasket portion 303. In this particular embodiment, the coupling portion 302 is depicted as running uninterruptedly down the length of sealing strip 301 to form a tongue/tenon. The tongue/tenon is intended to fit snuggly yet detachably from a mortise groove in another surface.

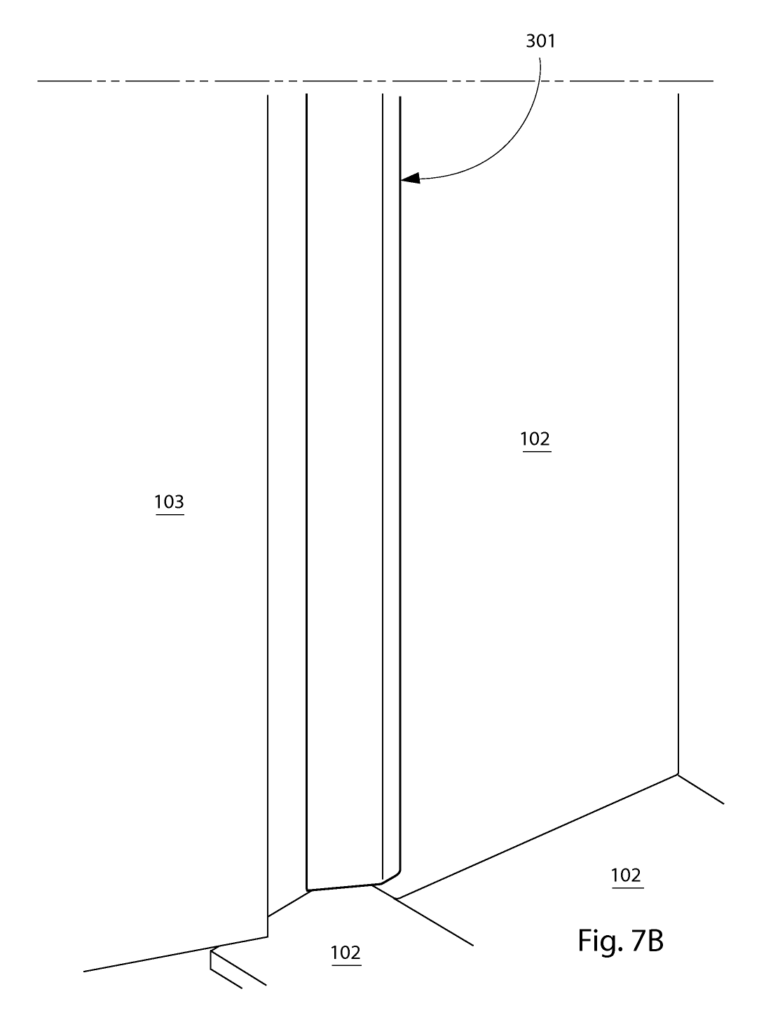

It is envisioned that coupling portion 302 may be an adhesive, a fastener or any other means for detachably coupling known to those of ordinary skill in the prior art. Consequently, coupling portion 302 is not limited to those running uninterruptedly down the length of sealing strip 301 and is not necessarily one continuous portion; instead, coupling portion 302 may be multiple discreet pieces and/or pieces that compliment/facilitate the means for the detachably coupling function. The result of this is that sealing strip 301 may supplant/supplement a previously installed prior art sealing strip (as is illustrated in FIGS. 7A-7B) or be installed as new.

Similarly, gasket portion 303 is depicted as having a shape and volume that is uniform and consistent throughout the length of sealing strip 301; however, gasket portion 303 is not limited to this. It is envisioned that the shape and volume of gasket portion 303 may be uniform, varied, etc. throughout its length. For example, as is illustrated in FIG. 5, it would be known to those of ordinary skill in the art that the cross-sectional area and shape of a specific point along gasket portion 303 defines the shape and volume of the gasket portion 303 at that specific point. Said another way, when the cross-sectional area and shape of multiple points along a length of gasket portion 303 are aggregated, then the shape and volume of gasket portion 303 at that specific length is defined. As such, even though FIGS. 3-6 depict one consistent cross-sectional area and shape, it is envisioned that the area and shape (and material composition) of each specific cross section throughout the length of gasket portion 303 may be uniform, varied, etc. Consequently, gasket portion 303 may also have a uniform, varied, etc. shape and volume throughout the length of sealing strip 301.

Moreover, like the shape and volume of the gasket portion 303, the area, shape and material composition of each portion of a cross-section is depicted in FIGS. 3-6 as being uniform and consistent throughout the entire cross-section; however, each individual cross-section of gasket portion 303 is not limited to this. It is envisioned that the area, shape and material composition of each portion of the cross-section may be uniform, varied, etc. throughout the entire cross section.

Regardless of the area, shape and material composition of the cross-sectional portions of gasket portion 303 (and their effects on the shape and volume of gasket portion 303 as a whole), gasket portion 303 functions to create a thermal, gas, liquid and/or particulate barrier between and an opening frame and a closure member by engaging with the closure member through a flexing portion 304. When the closure member engages with gasket portion 303, the closure member flexes flexing portion 304 at flex point 305; flex point 305 resists the force exerted by the closure member and causes the flexing portion 304 to press against the closure member. It is envisioned that sealing strip 301 may be attached to the closure member instead of the opening frame; thus, flexing portion 304 would press against the opening frame instead of the closure member. Moreover, it is envisioned that gasket portion 303 may have multiple discreet flex points 305 and/or pieces that compliment/facilitate the flexing portion 304 pressing against the closure member.

The function of gasket portion 303 to resist the forced exerted by the closure member and/or opening frame and to press against the closure member and/or opening frame is directly related to its material composition and structural design. Flexing portion 304 and flex point 305 of gasket portion 303 are composed primarily of semi-rigid thermoplastics or thermoplastic elastomers like polypropylene, polyethylene, nylon, urethane, polyester, polycarbonate, acrylonitrile butadiene styrene (“ABS”), polyvinyl chloride (“PVC”), Santoprene® (compound of EPDM rubber and polypropylene), Hytrel® (a thermoplastic polyester elastomer), Alcryn® (chlorinated olefin interpolymer alloy), and any other similar materials that would be known to those of ordinary skill in the art. These materials exhibit the necessary characteristics under the strain described above to resist the force exerted by the closure member and to cause the flexing portion 304 to press against the closure member and/or opening frame. The result is a gasket portion 303 that establishes a substantial and consistent seal and that maintains a uniform seal throughout the entire length of sealing strip 301.

By leveraging the pressing force exerted by flexing portion 304 and flex point 305, gasket portion 303 no longer relies on compressible elastomeric materials, such as elastomeric foams, to perform its intended and desired function. As a result, not only does gasket portion 303 benefit from the more rigid and durable materials (which do not sacrifice the quality of the seal), gasket portion 303 additionally benefits from a cross-sectional profile that is thinner.

With regard to durability, by comprising more rigid and durable materials, gasket portion 303 is less prone to degradation over time. This is true even when exposed to repeated mechanical interactions, e.g., repeated cycles of flex and strain when the seal is engaged or disengaged; or exposure to erosive forces (for example, from objects/particulates passing through the opening defined by the opening frame, or the gap between the opening frame and the closure member when the two are mated). Moreover, gasket portion 303 is also less prone to degradation from thermal or chemical interactions, e.g., exposure to extreme temperatures or humidity, or exposure to significant temperature or humidity fluctuations, relative to its intended use, when the seal is engaged or disengaged. Finally, gasket portion 303 does not require a liner or another type of exterior covering to prevent degradation although it is envisioned that gasket portion 303 may have a liner, surface coating, surface layer, etc. to provide additional durability benefits.

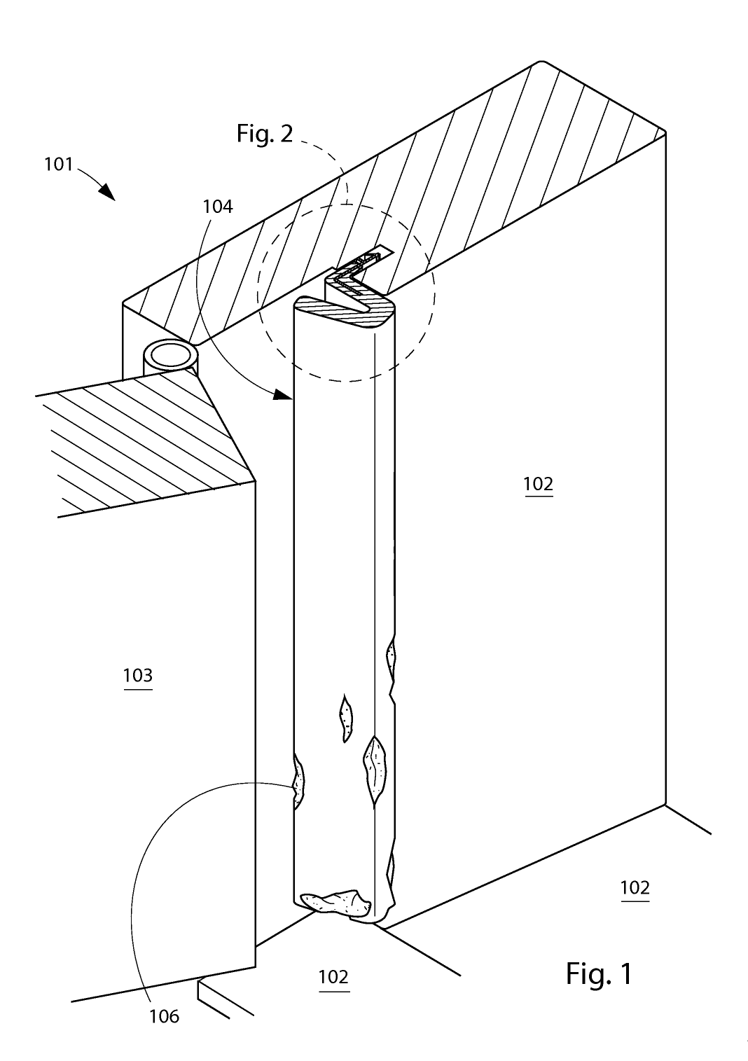

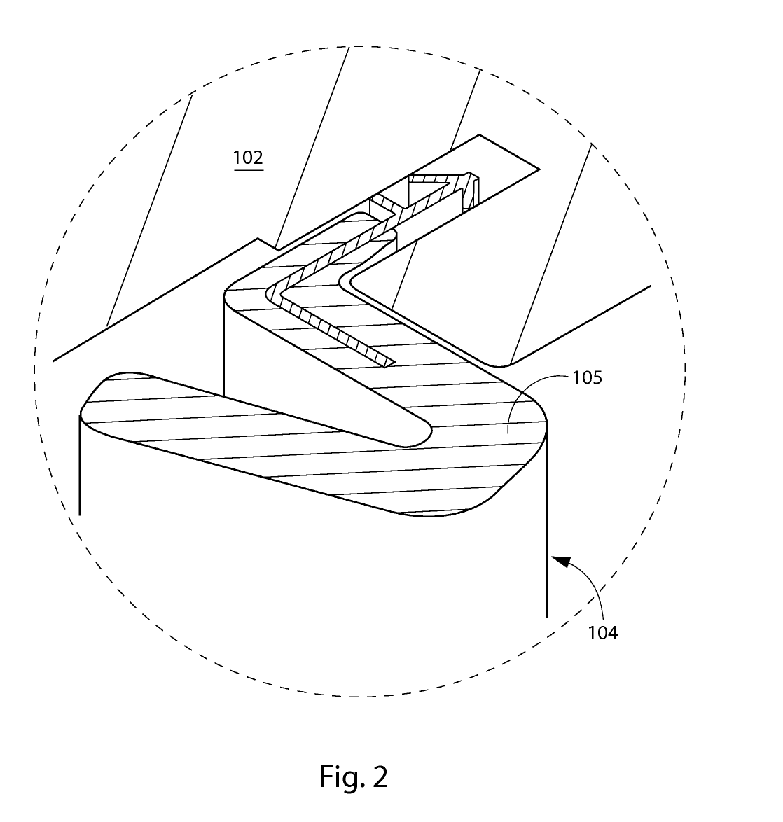

As is described more thoroughly above, the thinner cross-sectional profile, as depicted in FIG. 5 and compared to FIGS. 1-2, translates into a gasket portion 303 that has a reduced volume throughout the length of sealing strip 301. Consequently, when compared to the prior art, sealing strip 301 has a more streamlined structure that, without limitation: (1) does not sacrifice the quality of its seal; (2) minimizes the use of redundant and/or unnecessary manufacturing materials; and/or (3) lends itself to effective and efficient automated and semi-automated manufacturing process (like extrusion molding, etc.). Additionally, the reduced volume of gasket portion 303 allows for the incorporation of additional elements into sealing strip 301 that, without limitation: (1) facilitate/compliment its function as a thermal, gas, liquid and/or particulate barrier; (2) supplement it functions as a firewall element; and (3) add additional, noncontradictory, functions and features.

With regard to facilitating/complimenting gasket portion 303's function as a thermal, gas, liquid and/or particulate barrier, the reduced volume of gasket portion 303 allows for the incorporation of additional elements into sealing strip 301. For example, gasket portion 303 defines a channel that is substantially blocked from view in FIG. 3 and substantially exposed in FIG. 4. This channel is depicted as have a contoured plug 306 at certain portions along its length. FIG. 6 illustrates a cross-section of sealing strip 301 at a point along the length of gasket portion 303 where contoured plug 306 lies.

It is envisioned that contoured plug 306, and/or any other contoured/non-contoured blocks, plugs, walls or other similar structures known to those of ordinary skill in the art, may be introduced into the channel to, without limitation: supplement the pressing force of gasket portion 303 when it is engaged; to prevent drafts (the “chimney effect”) up the channel; to provide structural support for the flexing portion 304, i.e., to prevent over-flexing inwards (that could damage flex point 305, etc.). However, it is envisioned that neither the channel nor contoured plug 306 is a necessary element of sealing strip 301 because the shape and volume of gasket 303 along its length ultimately depends on the specific cross-sectional composition of gasket portion 303 (as explained more thoroughly above).

With regard to supplementing gasket portion 303's function as a firewall, the reduced volume of gasket portion 303 allows for the incorporation of additional elements into sealing strip 301. For example, contoured plug 306 is depicted as comprising intumescent materials; however, it is envisioned that contoured plug 306, and any similar structures, may be comprised of any other material with fire-barrier and/or fire retardant properties the would be known to those of ordinary skill in the art. It is additionally envisioned that these material with fire-barrier and/or fire retardant properties may be incorporated and positioned in various different locations along sealing strip 301 depending on the shape and volume of gasket 303 (as explained more thoroughly above).

Intumescent materials would be known by those of ordinary skill in the art to help retard the spread of fire. Intumescent materials may swell when exposed to relatively high temperatures. When swollen, the intumescent material is generally a poor conductor of heat; it also may fill any gaps and may extend to the surrounding areas. Unfortunately, combining intumescent materials with substantially any prior art embodiment of a sealing gasket 104 requires that the intumescent material be incorporated into portion 105, which: (1) decreases the efficacy of the intumescent material (by restricting its long term curing and restricting its expansion); (2) compromises the durability and function of the sealing gasket 104 (by interrupting and potentially damaging the most common elastomeric materials); and/or (3) compromises the limited durability benefits provided by a liner of portion 105 (by requiring a weakened and/or thinned portion of the liner to facilitate expansion and curing of the intumescent material).

Returning to sealing strip 301, regardless of its specific composition or position, when the right environmental conditions (such as high temperature, etc.) coincide with sealing strip 301, contoured plug 306 may expand to fill the gaps between the closure member and the opening frame, and may extend to the surrounding areas. Consequently, by not requiring the incorporation of intumescent materials directly into gasket portion 303, sealing strip 301 does not suffer from, without limitation: (1) air-flow restrictions to the intumescent material, which impede its long term curing; (2) expansion restrictions to the intumescent material, from having the intumescent material trapped within gasket portion 303 (and potentially a liner, etc.); and (3) gasket function deficiencies, from the intumescent material interacting chemically with gasket portion 303 and from the intumescent material interrupting the internal structure of gasket portion 303.

Moreover, the incorporation of materials with fire-barrier and/or fire retardant properties into sealing strip 301 may be additionally benefitted from the channel defined by gasket portion 303. Although not all of the embodiments of sealing strip 301 contain the exact channel illustrated in FIGS. 3-6, the reduced volume of gasket portion 303 inherently creates a relatively small amount of free space on one side or the other of sealing strip 301 when it is engaged with the closure member and the opening frame. This free space channels any expanding intumescent material or similar material along the length of the sealing strip 301. Consequently, this guided channeling of the expanding material helps ensure that the material with fire-barrier and/or fire retardant properties is positioned substantially evenly along the most critical junction of an effective firewall, the seal between the closure member and the opening frame.

While an illustrative embodiment of a sealing strip has been described in detail herein, it is to be understood that the inventive concepts may be otherwise variously embodied and employed and that the appended claims are intended to be construed to include such variations except insofar as limited by the prior art. Possible variations, as described throughout this disclosure, are not to be regarded as a departure from the spirit and scope of the invention, and all such modification as would be obvious to one skilled in the art are intended to be included within the scope of the preceding disclosure and the following claims.

It is understood that any variations of the features of the system and method described in the description section falls within the scope of the invention. There can be many embodiments of this invention as witnessed in some of the figures and the discussions of them. Not all embodiments of a sealing strip are represented here.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The various embodiments have been described using detailed descriptions of the embodiments, as well as features, aspects, etc., thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons with ordinary skill in the art.

It will be appreciated by persons with ordinary skill in the art that the present invention is not limited by what has been particularly shown and described herein above. Rather the scope of the invention is defined by the claims that follow.

What is claimed is:

1. A sealing strip comprising:
a coupling portion for detachably coupling the sealing strip to a primary surface;
a gasket portion, said gasket portion having a cross-section, wherein the cross-section is defined by an area, shape and material composition that defines:
a flexing portion;
a flex point; and
a channel that extends throughout the length of said gasket portion, said flexing portion configured to engage with a secondary surface such that said flexing portion flexes at said flex point when said coupling portion is coupled to the primary surface, said flex point resisting the flexing and forcing said flexing portion against the secondary surface, and said channel having a greater internal volume when said flexing portion is engaged with the secondary surface than when said flexing portion is not engaged with the secondary surface; and
a channel insert, said channel insert configured to fill at least a portion of said channel, to fit at least partially within said channel and to extend along at least a partial length of said channel.

2. The sealing strip of claim 1, wherein said coupling portion is selected from a group comprised of a tongue tenon and mortise groove, an adhesive and a fastener.

3. The sealing strip of claim 1, wherein at least some lengths along said gasket portion have varied cross sections as compared to other cross sections of said gasket portion.

4. The sealing strip of claim 1, wherein at least some portions of a cross section of said gasket portion have at least one varied defining characteristic selected from a group comprised of an area, shape and material composition, as compared to the other portions of a cross section of said gasket portion.

5. The sealing strip of claim 1, wherein the material composition of said gasket portion is substantially selected from a group comprised of polypropylene, polyethylene, nylon, urethane, polyester, polycarbonate, acrylonitrile butadiene styrene (“ABS”), polyvinyl chloride (“PVC”), Santoprene® (compound of EPDM rubber and polypropylene), Hytrel® (a thermoplastic polyester elastomer) and Alcryn® (chlorinated olefin interpolymer alloy).

6. The sealing strip of claim 1, wherein said channel insert has a cross section, the cross-section defined by an area, shape and material composition, wherein at least some lengths along said channel insert have varied cross sections as compared to other cross sections of said channel insert.

7. The sealing strip of claim 1, wherein said channel insert has a cross section, the cross-section defined by an area, shape and material composition, wherein at least some portions of a cross section of said channel insert have at least one varied defining characteristic selected from the group comprised of an area, shape and material composition as compared to the other portions of a cross section of said channel insert.

8. The sealing strip of claim 1, wherein the material composition of said channel insert is substantially selected from a group comprised of polypropylene, polyethylene, nylon, urethane, polyester, polycarbonate, acrylonitrile butadiene styrene (“ABS”), polyvinyl chloride (“PVC”), Santoprene® (compound of EPDM rubber and polypropylene), Hytrel® (a thermoplastic polyester elastomer), Alcryn® (chlorinated olefin interpolymer alloy), elastomeric foam, rubber, cork, fire retardant materials and intumescent materials.

9. The sealing strip of claim 1, wherein the material composition of said channel insert is at least partially selected from a group comprised of polypropylene, polyethylene, nylon, urethane, polyester, polycarbonate, acrylonitrile butadiene styrene (“ABS”), polyvinyl chloride (“PVC”), Santoprene® (compound of EPDM rubber and polypropylene), Hytrel® (a thermoplastic polyester elastomer), Alcryn® (chlorinated olefin interpolymer alloy), elastomeric foams, rubbers, corks, fire retardant materials and intumescent materials.

10. The sealing strip of claim 1, wherein at least some lengths along said channel insert have a cross section defined by a shape that substantially contours said channel member of said gasket portion.

11. A sealing strip comprising:
a coupling portion for detachably coupling the sealing strip to a primary surface; and
a gasket portion, said gasket portion having a cross-section, wherein the cross-section is defined by an area, shape and material composition that defines:
a flexing portion;
a flex point; and
a channel that extends throughout the length of said gasket portion, said flexing portion configured to engage with a secondary surface such that said flexing portion flexes at said flex point when said coupling portion is coupled to the primary surface, said flex point resisting the flexing and forcing said flexing portion against the secondary surface, and said channel having a greater internal volume when said flexing portion is engaged with the secondary surface than when said flexing portion is not engaged with the secondary surface.

12. The sealing strip of claim 1, wherein said coupling portion is selected from a group comprised of a tongue tenon and mortise groove, an adhesive and a fastener.

13. The sealing strip of claim 1, wherein at least some lengths along said gasket portion have varied cross sections as compared to other cross sections of said gasket portion.

14. The sealing strip of claim 1, wherein at least some portions of a cross section of said gasket portion have at least one varied defining characteristic selected from a group comprised of an area, shape and material composition as compared to the other portions of a cross section of said gasket portion.

15. The sealing strip of claim 1, wherein the material composition of said gasket portion is substantially selected from a group comprised of polypropylene, polyethylene, nylon, urethane, polyester, polycarbonate, acrylonitrile butadiene styrene (“ABS”), polyvinyl chloride (“PVC”), Santoprene® (compound of EPDM rubber and polypropylene), Hytrel® (a thermoplastic polyester elastomer) and Alcryn® (chlorinated olefin interpolymer alloy).

16. A sealing strip comprising:
a coupling portion for detachably coupling the sealing strip to a primary surface;
a gasket portion, said gasket portion having a cross-section, wherein the cross-section is defined by an area, shape and material composition that defines;
a flexing portion,
a flex point; and
a channel that extends throughout the length of said gasket portion, said flexing portion configured to engage with a secondary surface such that said flexing portion flexes at said flex point when said coupling portion is coupled to the primary surface, said flex point resisting the flexing and forcing said flexing portion against the secondary surface, and said channel having a greater internal volume when said flexing portion is engaged with the secondary surface than when said flexing portion is not engaged with the secondary surface; and
a channel insert, said channel insert comprising an intumescent material, said channel insert configured relative to the gasket portion to fill at least a portion of said channel, to fit at least partially within said channel and to extend along at least a partial length of said channel, said intumescent material configured to expand along and out of said channel.

17. The sealing strip of claim 3, wherein at least some lengths along said gasket portion have varied cross sections as compared to other cross sections of said gasket portion.

18. The sealing strip of claim 3, wherein at least some portions of a cross section of said gasket portion have at least one varied defining characteristic selected from a group comprised of an area, shape and material composition as compared to the other portions of a cross section of said gasket portion.

19. The sealing strip of claim 3, wherein said channel insert has a cross section, the cross-section defined by an area, shape and material composition, wherein at least some lengths along said channel insert have varied cross sections as compared to other cross sections of said channel insert.

20. The sealing strip of claim 3, wherein said channel insert has a cross section, the cross-section defined by an area, shape and material composition, wherein at least some portions of a cross section of said channel insert have at least one varied defining characteristic selected from the group comprised of an area, shape and material composition as compared to the other portions of a cross section of said channel insert.
